(19) United States
(12) Patent Application Publication
(10) Pub. No.: US 2018/0073672 A1
(43) Pub. Date: Mar. 15, 2018

(54) MACHINERY ASSEMBLY WITH MODULAR SKID

(71) Applicant: Mersino Dewatering, Inc., Davison, MI (US)

(72) Inventors: Curtis VARNER, Burton, MI (US); Timothy LILEY, Grand Blanc, MI (US); Benjamin LINDSTROM, Lansing, MI (US)

(21) Appl. No.: 15/706,219

(22) Filed: Sep. 15, 2017

Related U.S. Application Data
(60) Provisional application No. 62/395,073, filed on Sep. 15, 2016.

(51) Int. Cl. F16M 3/00; F04B 17/06; F04B 35/06

(52) U.S. Cl. CPC F16M 3/00; F04B 35/06; F04B 17/06

(57) ABSTRACT

A modular skid for supporting a machinery assembly. The modular skid includes a skid base with opposing side rails and a support deck extending there between. The modular skid further includes a skid extension and an end cap. The skid extension including an extension support deck having a width corresponding to the width of the skid base. One end of the skid extension is configured to mount to the mounting features of the skid base. At an opposing end of the skid extension, the extension side rails defining extension mounting features of the skid extension. The extension mounting features have a configuration that corresponds to the base mounting features. The end cap includes end cap mounting structures configured to be alternately mounted to the base mounting features or the extension mounting features.

### CROSS REFERENCE TO RELATED APPLICATION

This application is a non-provisional application and claims priority to U.S. provisional patent application No. 62/395,073 filed Sep. 15, 2016, the entire contents of which are herein incorporated by reference.

### BACKGROUND

### 1. Field of the Invention

The present invention generally relates to a skid for supporting various machinery components. More specifically, the invention relates to a modular skid that is reconfigurable for supporting different machinery configurations, thereby allowing the machinery builder to maintain less inventory with regard to components of the skid.

### 2. Description of Related Art

Skid assemblies are used for supporting and transporting a wide variety of machinery components including, for example, a dewatering pump assembly having an engine and a pump head. Typically, a manufacturer stocks a variety of engines and pump heads, and a customer specifies a specific configuration of engine and pump head that they would like to acquire. Additionally, the customer may specify the transportability of the configuration, i.e. trailering or non-trailering, as well as being configured as an enclosed or open unit. As a result, the manufacturer is required to stock skid assemblies for each possible configuration of engine, pump head and transportability. This results in a large inventory of skids being maintained by the manufacturer. Depending on the number of different engine and pump head combinations, this may be as many as 70 different skids to accommodate all of the possible configurations.

In view of the above, it is seen that there is a need to reduce the amount of skid inventory maintained by a manufacturer, while still offering customers with the widest possible selection of machinery configurations.

### SUMMARY

In satisfying the above need, as well as overcoming the enumerated drawbacks and other limitations of the related art, the present invention provides, in one aspect, a modular skid for supporting a pump configuration. The modular skid includes a skid base having a base support deck extending between opposing base side rails. On at least one end of the skid base, the base side rails have longitudinal ends that extend to define base mounting ends or features of the skid base. The modular skid also includes a skid extension having an extension support deck extending from or between opposing extension side rails. One end of the skid extension is configured to mount to the base mounting features of the skid base. At an opposing end of the skid extension, the extension side rails have longitudinal ends extending to or beyond an end of the extension support deck and which define extension mounting features of the skid extension. The extension mounting features have a configuration corresponding to the base mounting features. The modular skid also includes an end cap with a width extending from and between the base side rails. The end cap includes mounting structures on ends thereof and the mounting structures are configured to be alternately mounted to one of the base mounting ends and extension mounting ends.

Accordingly, the modular skid allows a manufacturer to support a wide variety of pump configurations while reducing the skid inventory that the manufacturer must maintain.

In a further aspect of the invention, a pump assembly is provided in which a pump head is coupled to a prime mover, such as an engine or motor, and supported on a modular skid. The modular skid includes a skid base and at least one modular components selected from the group of a skid extension, an end cap, a lifting bail, a trailering tongue, an axle assembly, and a housing. The skid base includes a base support deck extending between opposing base side rails. On at least one end of the skid base the base side rails have longitudinal ends extending beyond an end of the base support deck and defining base mounting ends of the skid base. The skid extension includes an extension support deck extending between opposing extension side rails. One end of the skid extension is configured to mount to the base mounting ends of the skid base and, at an opposing end of the skid extension, the extension side rails have longitudinal ends extending beyond an end of the extension support deck and defining extension mounting ends of the skid extension. The extension mounting ends have a configuration corresponding to the base mounting ends. The end cap has a width configured to extend between the base side rails. The end cap further has mounting structures on the ends thereof, and the mounting structures are configured to be alternately mounted to one of the base mounting ends and extension mounting ends. The trailering tongue is configured to be connected to the skid base at one of a receiver centrally located between the base side rails, the base mounting portions and the extension mounting portions. The axle assembly is either a single axle assembly or a dual axle assembly. The housing includes side walls mounted along perimeter sides of the skid base and further defines a sound attenuation chamber at one end of the housing that is configured to be located above the skid extension.

Further objects, features and advantages of this invention will become readily apparent to persons skilled in the art after review of the following description with reference to the drawings and the claims that are appended to inform a part of this specification.

### BRIEF DESCRIPTION OF THE DRAWINGS

FIG. 1A is an assembled perspective view of one configuration of a modular skid according to one aspect of the present invention;

FIG. 1B is an exploded view of the modular skid seen in FIG. 1;

FIG. 1C is a perspective view of a pump assembly incorporating the modular skid of FIG. 1A with an engine and pump head mounted thereon;

FIG. 2A is an assembled perspective view of a trailering version, without the axle assembly, of the modular skid

FIG. 2B is an exploded view of a trailering version, without the axle assembly, of the modular skid seen in FIG. 2A;

FIG. 2C is a perspective view of a pump assembly incorporating the trailering version of modular skid of FIG. 2A, with the axle assembly illustrated, a pump head and an engine;

FIGS. 3A and 3B are, respectively, assembled perspective and exploded views of a pump assembly with a second trailering version of the modular skid;

FIG. 3C is a perspective view of a pump assembly incorporating the second trailering version of the modular skid of FIG. 3A;

FIG. 4A is an assembled perspective view of another configuration of the modular skid according to an aspect of the present invention;

FIG. 4B is an exploded view of the modular skid seen in FIG. 4A;

FIG. 4C is a perspective view of a pump assembly incorporating the modular skid seen in FIG. 4A with an engine and pump head mounted thereon;

FIGS. 4D and 4E are, respectively, perspective and cross-sectional views of the pump assembly seen in FIG. 4C having a sound attenuating housing mounted thereon;

FIG. 5A is an assembled perspective view of a trailering version, without the axle assembly, of the modular skid seen in FIG. 4A;

FIG. 5B is an exploded view of the trailering version of the modular skid seen in FIG. 5A;

FIG. 5C is a perspective view of a pump assembly having an engine and pump head mounted on the trailering version of the modular skid seen in FIG. 5A; and

FIGS. 5D and 5E, respectively, are perspective and cross-sectional views of the pump assembly seen in FIG. 5C having a sound attenuating housing mounted thereon.

### DETAILED DESCRIPTION

As used in the description that follows, directional terms such as “upper” and “lower” are used with reference to the orientation of the elements as presented in the figures and how they would be encountered in actual usage. Accordingly, “upper” indicates a direction toward the top of the figure and “lower” indicates a direction toward the bottom of the figure. The terms “left” and “right” are similarly interpreted. The terms “inward” or “inner” and “outward” or “outer” indicate a direction that is generally toward or away from a central axis of the referred to part whether or not such an axis is designated in the figures. An axial surface is therefore one that faces in the axial direction. In other words, an axial surface faces in a direction along the central axis. A radial surface therefore faces radially, generally away from or toward the central axis. It will be understood, however, that in actual implementation, the directional references used herein may not necessarily correspond with the installation and orientation of the corresponding components or device.

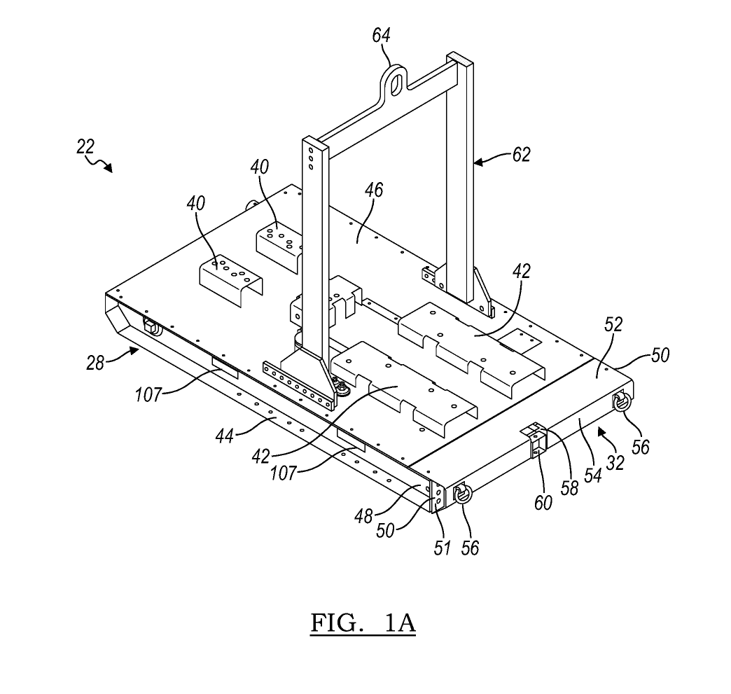

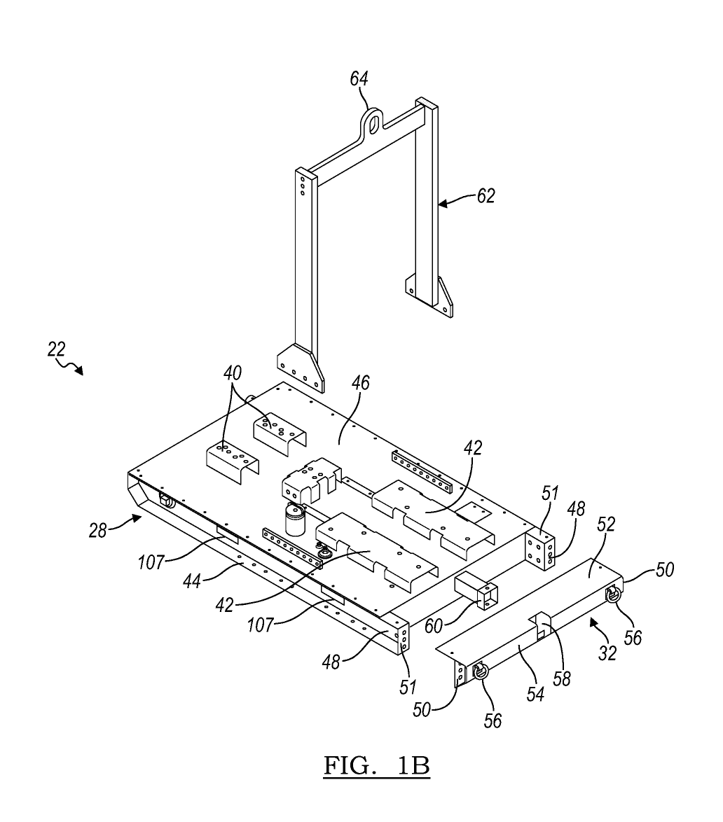

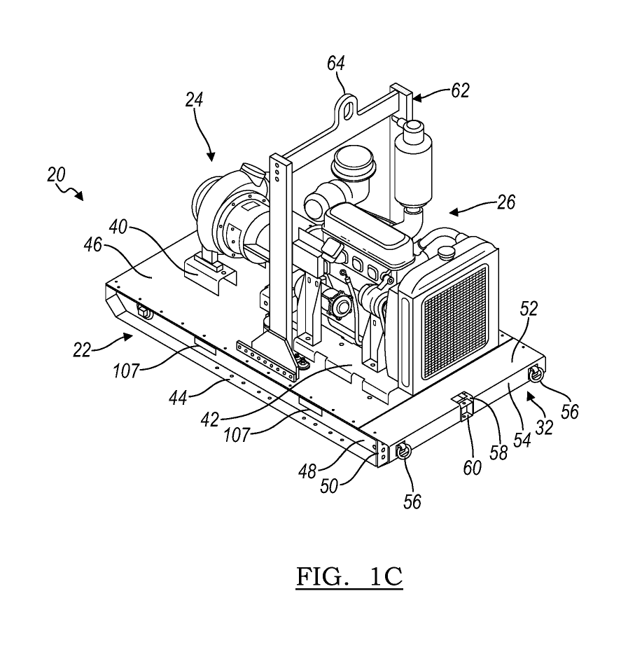

Referring now to the drawings, a pump assembly embodying the principles of the present invention is illustrated in the figures in various configurations and generally designated at 20. As seen in the depiction of the pump assembly 20 in FIG. 1C, the pump assembly 20 includes a modular skid 22 that supports a pump head 24 and a prime mover 26, such as a gas or diesel engine or an electric motor (hereafter just “engine 26”). The prime mover 26 is coupled to the pump head 24 so as to drive or operate the pump head 24. The pump head 24 and engine 26, as well as their coupling together, are all well-known and, therefore, not described in greater detail herein. Generally, the modular skid 22 includes, as its principal components, a skid base 28 and at least one modular component selected from the group of a skid extension 30, an end cap 32, a trailering tongue 66, 70, an axle assembly 36, a lifting bail 62 and a sound attenuating housing 90. These components are illustrated in the figures in connection with the configurations of the pump assembly 20 and modular skid 22 in which they are utilized.

The pump head 24 and engine 26 are respectively supported by the skid base 28 on pump mounting structures 40 and engine mounting structures 42. The pump head and engine mounting structures 40, 42 are formed as multiple risers on the skid base 28 and are each provided with at least one mounting hole and access opening that allow the mounting structures 40, 42 to accommodate a variety of different pump heads 24 and engines 26, which would be specified by the end customer. The pump head and engine mounting structures 40, 42 need not be provided exactly as illustrated in the figures. For example, the engine mounting structures 42 is illustrated as being comprised of two individual risers. These risers 42 may, however, be provided as a configuration of four distinct risers, two forward and two more rearward, with each having mounting holes and access openings. The pump head and engine mounting structures 40, 42 may also include, as a part thereof, variously sized shims (not shown) for the purpose of raising and lowering the pump head 24 and/or engine 26 relative to one another and the skid base 28. Through the provision of the mounting structures 40, 42, including the shims, the output of the engine 26 may be axially and vertically aligned with respect to the input of the pump head 24, or a coupling unit (not shown), and connected together.

Referring now to FIGS. 1A, 1B and 1C, illustrated therein is the modular skid 22 in a short skid configuration incorporating the base skid 28 and the end cap 32. As seen in FIG. 1A, the base skid 28 includes a pair of opposed base side rails 44 and a support deck 46 that extends between the base side rails 44. The base side rails 44 are of a strong and rigid construction and, as such, may be provided in the form of a variety of different structural elements. For example, the base element of the base side rails 44 may be provided in the form a channel rail (shown in the figures), a box rail or an I-beam rail. The support deck 46 forms the surface upon which the mounting structures 40, 42 are located and may also be integrated with a fuel-cell used to provide fuel to the engine 26. A fill tube for the fuel-cell may extend up through the support deck 46, and is generally as shown in the figures.

While not required, the support deck 46 preferably extends across the full width of the skid base 28, over the tops of the base side rails 44 and, if desired, laterally beyond the outer edge of base side rails. The length of the support deck 46 may or may not extend the full length of the base side rails 44, so long as the longitudinal ends of the base side rails 44 define mountings 48 for the various other components, as discussed below. In the illustrated embodiments, the support deck 46 extends to a location just short of the ends base side rails 44.

As noted above, the base mountings 48 allow for the mounting of other components of the modular skid 22 to the skid base 28. In FIGS. 1A, 1B and 1C, an end cap 32 is illustrated in association with the skid base 28.

The end cap 32 extends the width between the base mountings 48 and includes corresponding end cap mountings 50 that enable the end cap 32 to be secured to the skid base 28. As such, the end cap mountings 50 may be secured to the base mountings 48 by threaded fasteners, such as nuts and bolts extending through corresponding bolt holes defined in both the base and end cap mountings 48, 50. Alternatively, the base and end cap mountings 48, 50 may be welded together or secured by other known means. The end cap 32 additionally includes an upper face 52 that defines a substantially flush surface with the support deck 46 of the base skid 28. The end cap 32 also includes a front face 54 extending across the base mountings 48. The front face 54 may be provided with shackles 56 enabling the modular skid 22 to be towed or dragged to the desired location. Additionally, the front face 54 may be provided with an opening 58 providing access to a receiver 60 coupled to the base skid 28.

An optional feature, illustrated in connection with each configuration, is a lifting bale 62. Lifting bale 62 is a frame like structure that includes a chain, cable or hook attachment point 64 that allows for the modular skid 22 and/or the entire pump assembly 20 to be lifted by a crane, cherry picker, front end loader or other similar machinery with lifting capabilities. Lifting bale 62 is secured to the skid base 28, preferably to the base side rails 44 or a similarly strong component connecting to the base side rails 44.

It should be noted that each of the construction variations and alternatives, mentioned above in connection with the short skid configuration, the modular skid 22 and/or the skid base 28, are individually and collectively equally applicable to each additional configuration discussed herein or contemplated herewith. The discussion that follows details various other such configurations utilizing the base skid 28.

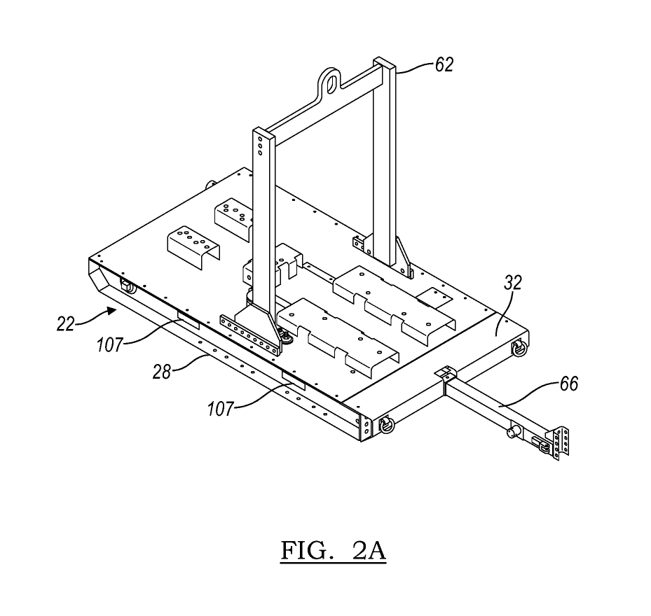

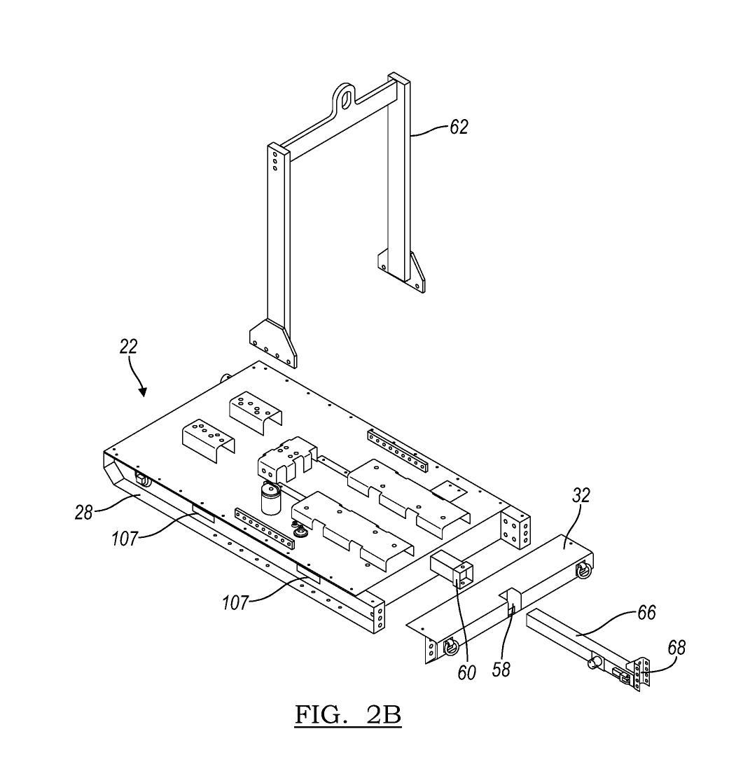

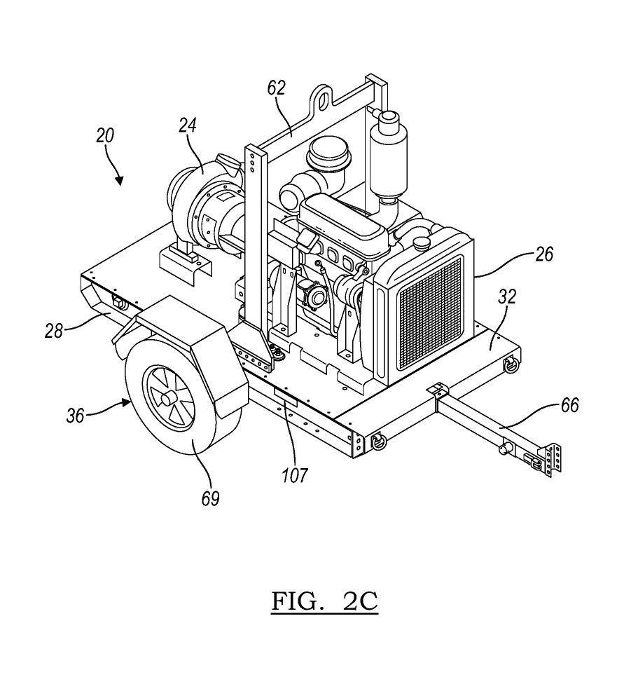

Referring now to FIGS. 2A, 2B and 2C, the short skid configuration of FIGS. 1A, 1B and 1C is modified into a short trailering configuration through additional components of the modular skid 22. Specifically, the short trailering configuration additionally includes a trailering tongue 66, provided as an axial bar, square tube or other member, which extends through the opening 58 in the front face 54 of the end cap 32 and into the receiver 60 of the skid base 28. The trailering tongue 66 may be attached to the receiver 60 through conventional techniques including use of a hitch pin, threaded fastener and or welding. The opposing end of the trailering tongue 66 includes a trailering coupling 68, which may be one of various well-known varieties. Not seen in FIG. 2B, but illustrated in FIG. 2C, the short trailering configuration additionally includes an axle assembly 36 mounted to the skid base 28 and which includes well-known axle assembly components such as a single axle 69, suspension components, wheels, tires and fenders.

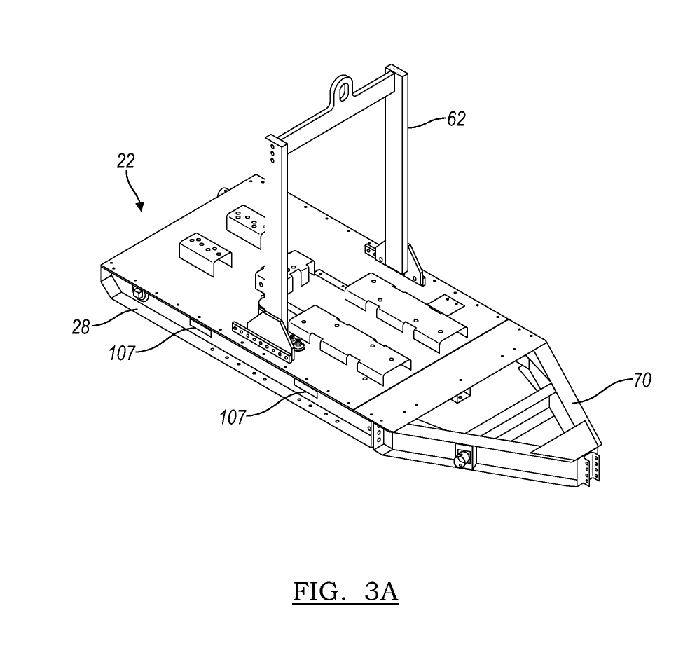

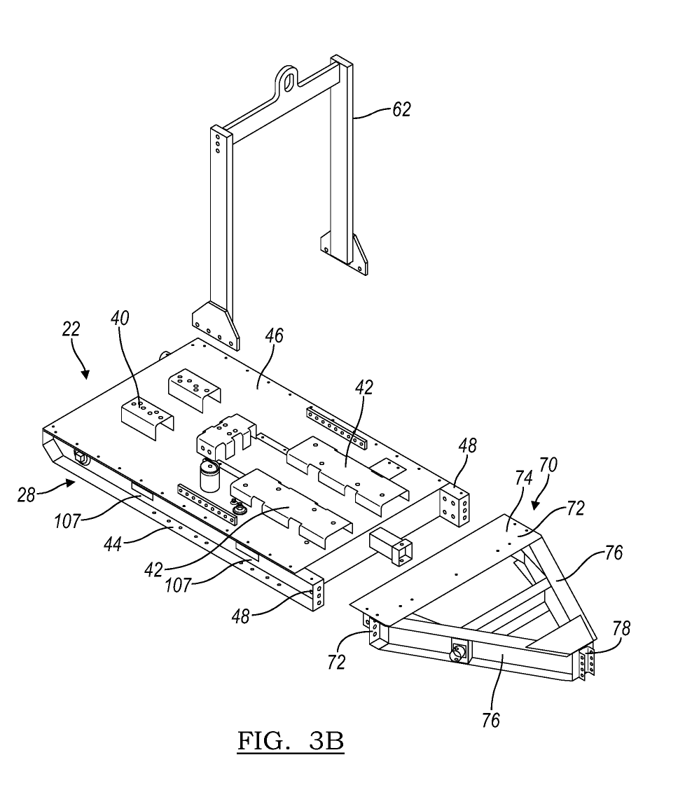

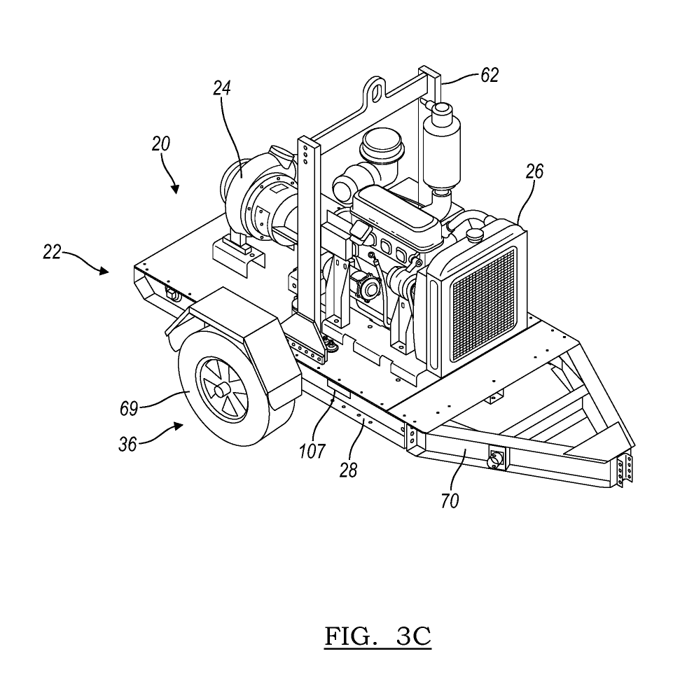

Depending on the pump head 24 and engine 26 specification, a more robust trailering configuration may be required. As seen in FIGS. 3A, 3B and 3C, a heavy duty short trailering configuration is illustrated. In this configuration, the end cap 32 is replaced by a V-nose trailering tongue 70. The V-nose trailering tongue 70 includes tongue mounting 72 that are configured to mount to the base mountings 48 in the same or similar manner as the end cap mountings 50 discussed previously. The V-nose trailering tongue 70 also includes an upper face 74, generally corresponding to the upper face 52 of the end cap 32 and providing a flush surface with the support deck 46 of the skid base 28. Extending from the tongue mountings 72 are frame members 76 that converge at a coupling 78 for attachment to the trailering vehicle. Illustrated in FIG. 3B, the heavy duty short trailering configuration is also provided with a single axle assembly 36, 69.

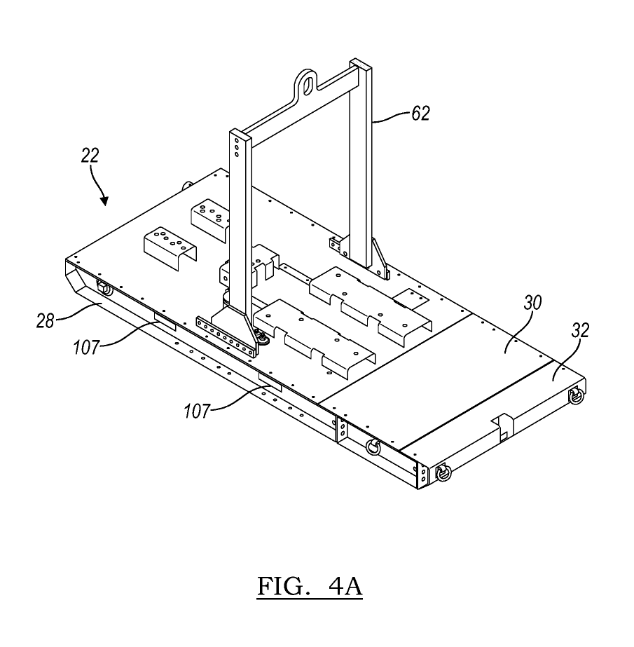

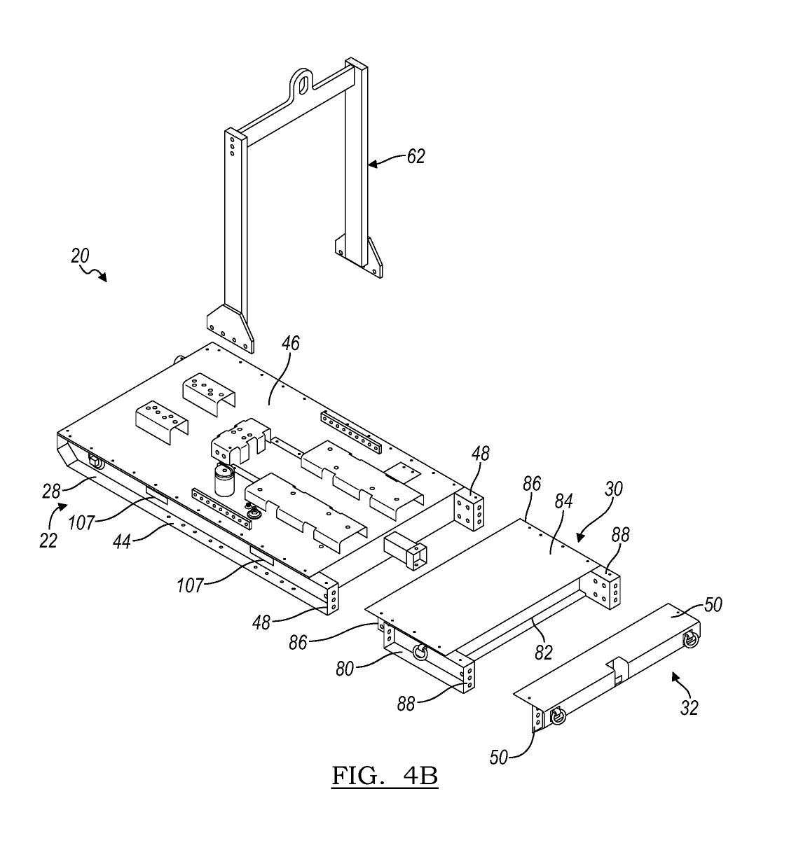

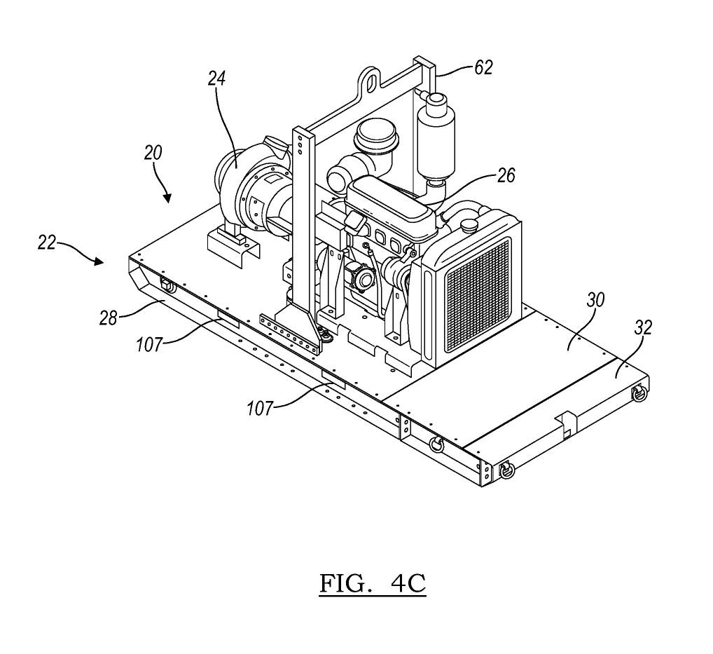

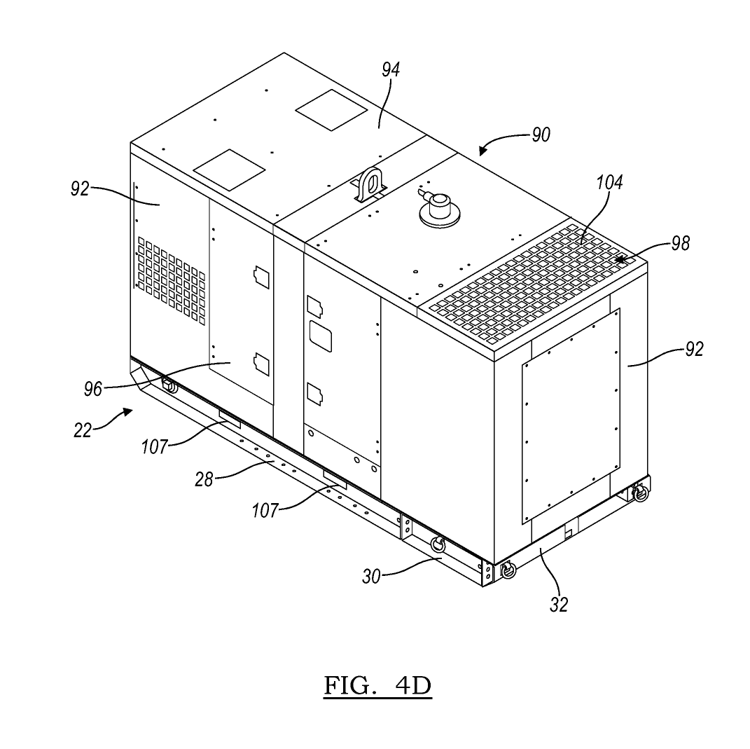

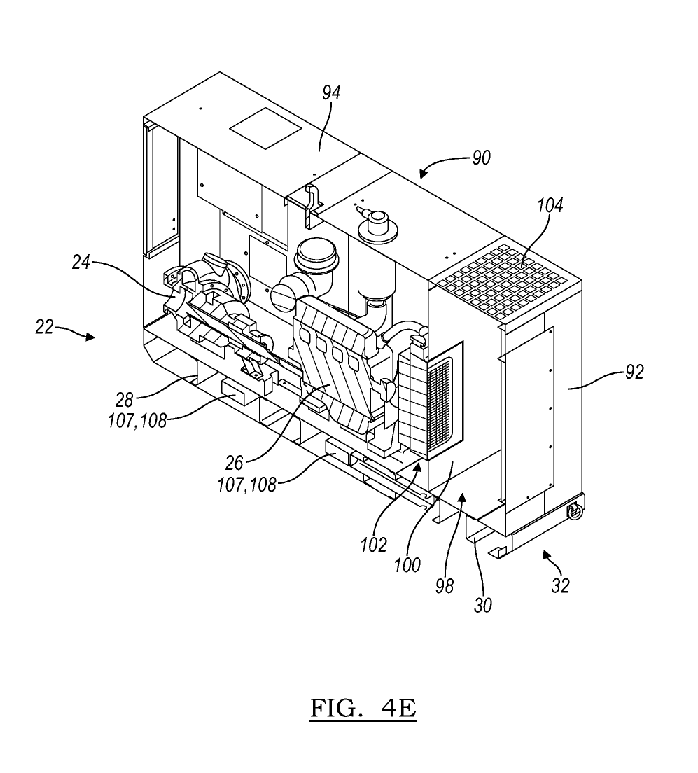

In situations where the pump head 24 and engine 26 require additional room, the modified skid 22 of the pump assembly 20 may be provided in a long skid configuration. This configuration is illustrated in FIGS. 4A, 4B and 4C. As seen therein, the long skid configuration and incorporates the aforementioned skid extension 30 between the skid base 28 and the end cap 32. The skid extension 30 includes a pair of opposing extension side rails 80 with cross support members 82 and an extension support deck 84 extending there between. At one end, generally adjacent to the extension side rails 80, the skid extension 30 is provided with extension mountings 86 that are configured to mount to the base mountings 48 in the same or a similar manner as the end cap mountings 50. At the opposing end the extension side rails 80 define second extension mountings 88 that are or may be substantially identical to the base mountings 48, thereby allowing the end cap mountings 50 to be mounted to the second extension mountings 88. The end cap 32 is configured as previously discussed.

If sound attenuation of the pump head 24 and engine 26 is desired, a sound attenuation housing 90 may be provided. As seen in FIGS. 4D and 4E, the sound attenuation chamber 90 is provided on the long skid configuration seen in FIGS. 4A, 4B and 4C. The sound attenuation housing 90 includes side walls 92 and top walls 94 that enclose the pump head 24 and engine 26. The sidewalls include appropriate doors 96 so that access may be gained to the pump head 24 and engine 26 as required. At one end, the sound attenuation housing 90 includes a sound attenuation chamber 98. The sound attenuation chamber 98 is defined by an internal wall 100 between opposing side walls 92, which has has an opening 102 therein, preferrably corresponding with a portion the cooling system, such as the radiator, of the engine 26. At its top, the sound attenuation chamber 98 is open and preferably covered by a grate 104, not a solid wall, to facilitate air intake and cooling, as well as to direct sound only upwards out of the chamber 98.

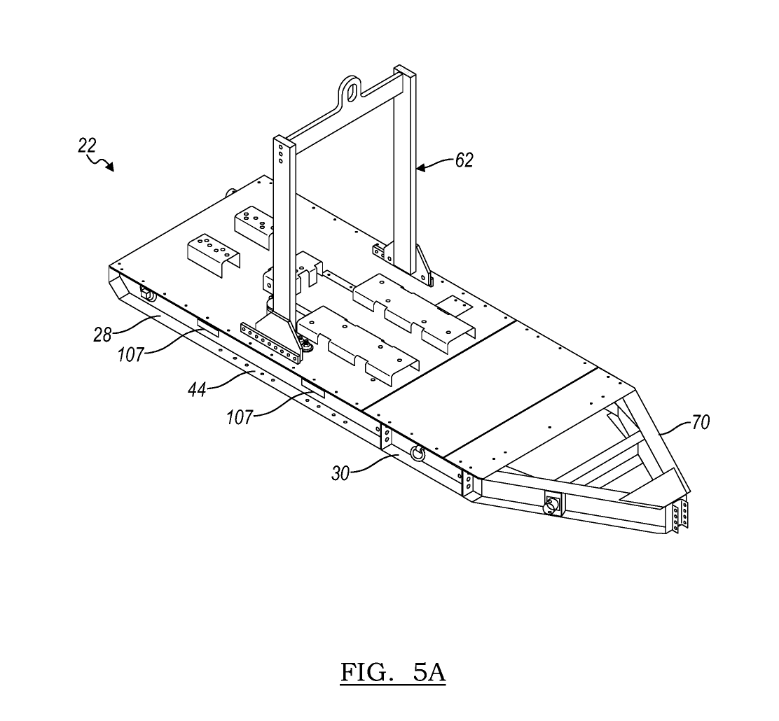

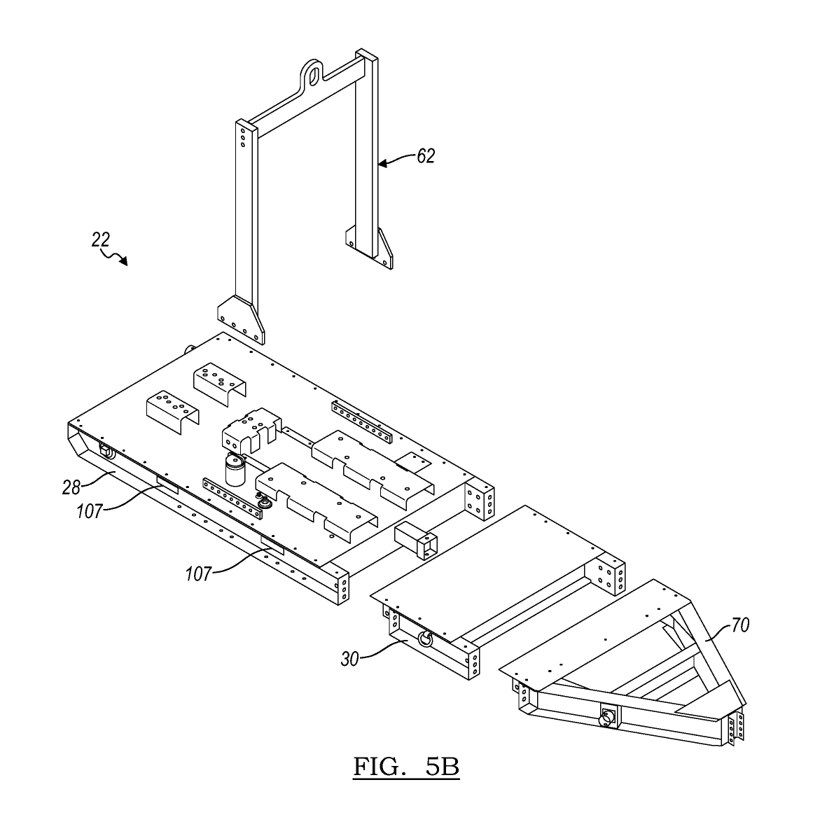

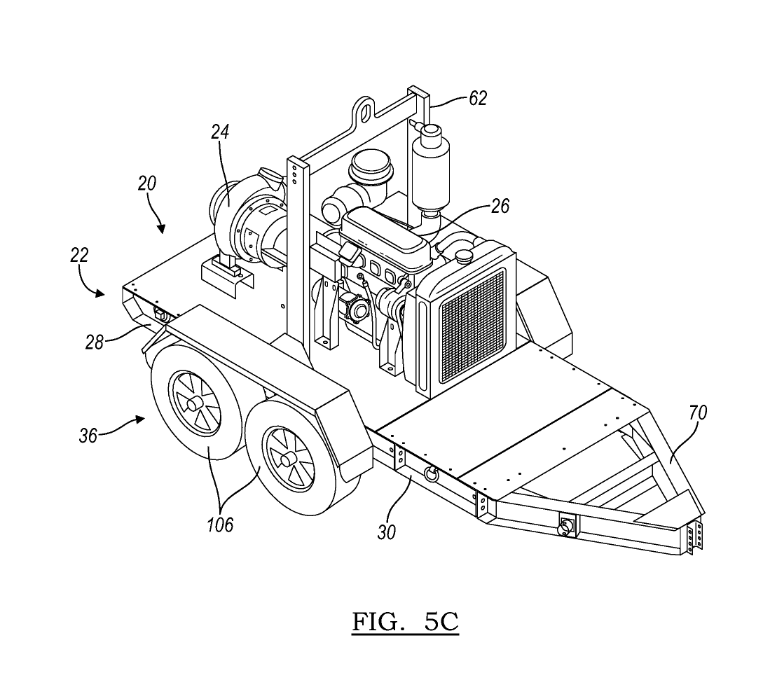

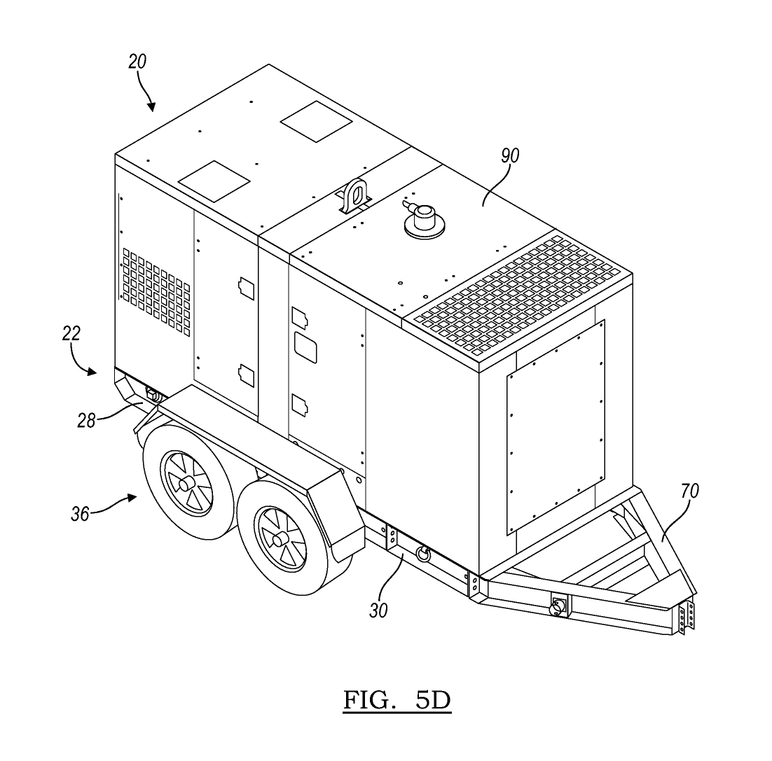

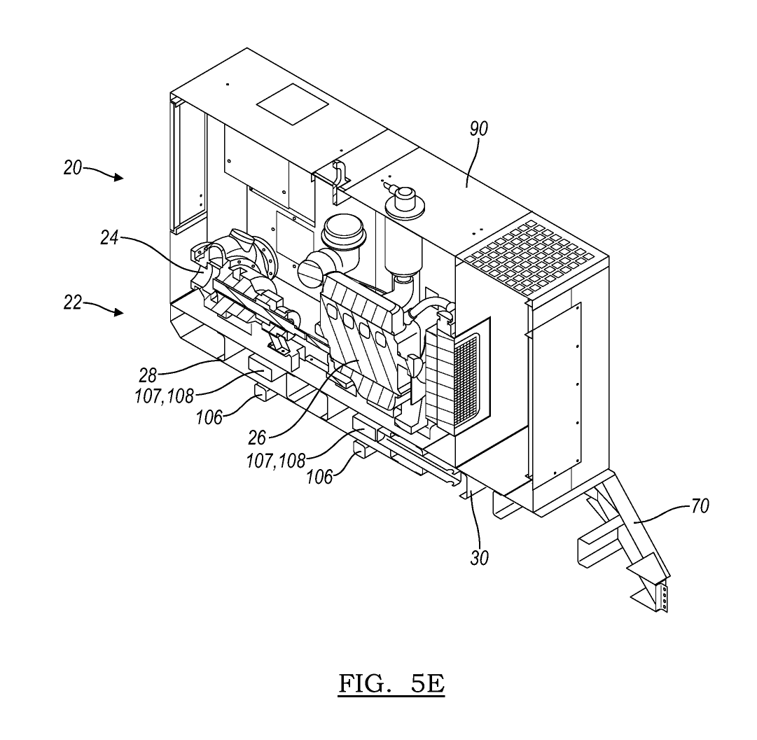

Referring now to FIGS. 5A-5E, the long skid configuration of FIGS. 4A, 4B and 4C may be provided in a long heavy-duty trailering configuration similar to the heavy-duty trailering configuration previously discussed. In this regard the end cap 32 is removed from the long skid configuration and is instead replaced with the V-nose trailering tongue 70. The V-nose trailering tongue 70 is also capable of mounting to the skid extension 30 because the second extension mountings 88 are identical to the base mountings 48. As seen in FIG. 5C, the axle assembly 36 for the trailering configuration may be provided as a double-axle assembly 106. If sound attenuation is desired, this long heavy-duty trailering configuration may additonall be provided with the previously discussed sound attenuating housing 90, as seen in FIGS. 5D and 5E. The previously discussed sound attenuation housing 90 readily mounts to this configuration of the modular skid 22 because the upper face 74 of the V-nose trailering tongue 70 corresponds substantially identically to the upper face 52 of the end cap 32.

As seen in each of the figures, the base skid 28 includes spaced apertures 107 in the base side rails 44. The apertures 107 are configured to receive the fork lift tines. As seen in FIG. 5E, the apertures 107 may be defined by a rectangular tubes 108 extending from and through one base side rail 44 to the other base side rail 44. Provided in this manner, the rectangular tube 108 restricts and directs inserted fork lift tines so as to prevent damage to any other components mounted or extending beneath the support deck 46 and between the base side rails 44, such as a fuel cell for the engine 26.

As a person skilled in the art will really appreciate, the above description is meant as an exemplary illustration of implementation of the principles of the present invention. This description is not intended to limit the scope or application of this invention since the invention is susceptible to modification, variation and change without departing from the spirit of this invention, as defined in the following claims.

I/we claim:

1. A modular skid for supporting a machinery configuration, the modular skid comprising:
a skid base including a base support deck extending between opposing base side rails, on at least one end of the skid base the base side rails having longitudinal ends, the longitudinal ends including base mountings features of the skid base;
a skid extension including an extension support deck extending between opposing extension side rails, one end the skid extension being configured to mount to the base mounting features of the skid base, at an opposing end of the skid extension the extension side rails having longitudinal ends including extension mounting features of the skid extension, the extension mounting features having a configuration corresponding to the base mounting features; and
an end cap having a first width, the end cap having end cap mounting structures thereof and the end cap mounting structures being configured to be alternately mounted to one of the base mounting features and extension mounting features.

2. The modular skid of claim 1, wherein the extension mounting features and the base mounting features have identical configurations.

3. The modular skid of claim 1, wherein the base mounting features extend beyond the base support deck by a first distance and the extension mounting features extend beyond the extension support deck by a second distance, the second distance being the same as the first distance.

4. The modular skid of claim 1, further comprising a pump head mount and an engine mount extending from the base support deck, the pump head mount being configured to mount a plurality of different pump heads thereon, the engine mount being configured to mount a plurality of different engines thereon whereby the engine is configured to be coupled to the pump head.

5. The modular skid of claim 1, further comprising a lifting bale mounted to the skid base and extending generally perpendicular to the support deck.

6. The modular skid of claim 1, further comprising at least one axle assembly mounted to the skid base and a trailering tongue configured to be connected to the skid base.

7. The modular skid of claim 7, wherein the trailering tongue includes tongue mounting structures on an end thereof, the tongue mounting structures being configured to be alternately mounted to the base mounting features and extension mounting features.

8. The modular skid of claim 7, wherein the trailering tongue has a converging V-shape extending to a hitch mounting structure.

9. The modular skid of claim 7, wherein the trailering tongue engages a receiver centrally located on the skid base between the base side rails.

10. The modular skid of claim 1, further comprising a housing including side walls mounted along perimeter sides of the skid base, the housing further defining a sound attenuation chamber at one end of the housing and configured to be located above the skid extension with the skid extension attached to the skid base.

11. The modular skid of claim 1, wherein base support deck and the extension support deck are configured to be flush with one another.

12. The modular skid of claim 1, wherein at the one end of the skid extension the extension support deck extends beyond the extension side rails.

13. A machinery assembly comprising:
a pump head;
a prime mover coupled to the pump head;
a modular skid supporting the pump head and the prime mover, the modular skid including a skid base and at least one modular component selected from the group of a skid extension, an end cap, a trailering tongue, an axle assembly, and a housing;
wherein the skid base includes a base support deck extending between opposing base side rails, on at least one end of the skid base the base side rails having longitudinal ends including portions defining base mounting features of the skid base;
wherein the skid extension includes an extension support deck extending between opposing extension side rails, one end of the skid extension being configured to mount to the base mounting features of the skid base, at an opposing end of the skid extension the extension side rails having longitudinal ends defining extension mounting features of the skid extension, the extension mounting features having a configuration corresponding to the base mounting features;
wherein the skid base, the skid extension and the end cap each have a width corresponding to one another, the end cap further having mounting structures on an end thereof and the mounting structures being configured to be alternately mounted to the base mounting features or the extension mounting features;
wherein the trailering tongue is configured to be connected to the skid base at one of a receiver centrally located between the base side rails, the base mounting features and the extension mounting features;
wherein the axle assembly is one of a single axle assembly and a dual axle assembly; and
wherein the housing includes side walls configured to be mounted along perimeter sides of the skid base, the housing further defining a sound attenuation chamber at one end of the housing and configured to be located above the skid extension.

14. The machinery assembly of claim 13, wherein the extension mounting features and the base mounting features are identical.

15. The machinery assembly of claim 13, wherein the base mounting features extend beyond the base support deck by a first distance and the extension mounting features extend beyond the extension support deck by a second distance, the second distance being the same as the first distance.

16. The machinery assembly of claim 13, further comprising a pump head mount and an engine mount extending from the base support deck, the pump head mount being configured to mount a plurality of different pump heads thereon, the engine mount being configured to mount a plurality of different engines thereon whereby the engine configured to be coupled to the pump head.

17. The machinery assembly of claim 13, further comprising a lifting bale mounted to the skid base and extending generally perpendicular to the support deck.

18. The machinery assembly of claim 13, wherein the skid base include transverse apertures extending between the base side rails and configured to receive fork lift tines.
